(19) United States
(12) Patent Application Publication
(10) Pub. No.: US 2008/0050185 A1
(43) Pub. Date: Feb. 28, 2008

(54) Helical cutterhead

(75) Inventors: Joseph G. Strouse, Williamsport, PA (US); Matthew W. Strouse, Williamsport, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Hermance Machine Company, Williamsport, PA (US)

(21) Appl. No.: 11/895,265

(22) Filed: Aug. 23, 2007

Related U.S. Application Data
(60) Provisional application No. 60/839,455, filed on Aug. 23, 2006.

(51) Int. Cl. B26D 1/12

(52) U.S. Cl. 407/59

(57) ABSTRACT

A cutterhead for shaping materials. The cutterhead includes a substantially cylindrical body with at least one helically-shaped recess defining a helically-shaped projecting surface having a cutting side and multiple seats positioned along the projecting surface. The seats receive removable cutting blades and include a planar seat surface. The seat surfaces are oriented to appropriately align the projecting blade edge of the blade to a helical angle. In addition, the seats include a connection arrangement for removably attaching the blade.

### CROSS REFERENCE TO RELATED APPLICATIONS

This application claims priority to U.S. Provisional Patent Application No. 60/839,455, filed Aug. 23, 2006, which is incorporated herein by reference in its entirety.

### BACKGROUND OF THE INVENTION

1. Field of the Invention

The present invention relates generally to helical cutterheads and similar appliances for shaping surfaces of various materials and, in particular, to a helical cutterhead and cutting system for use in a variety of applications, including planer, molder and jointer systems for working with wood and similar materials.

2. Description of Related Art

Helical cutterheads have been used extensively in a variety of applications in order to shape and work with materials. In order to shape the target materials, such helical cutterheads include cutting edges or blades machined into the cutterhead for contacting and shaping the surface of the material. In addition, other helical cutterheads use elongated cutting blades mounted to a cutterhead along a cutting side or edge, and these blades may be replaceable and, together, span the width of the cutterhead. A variety of helically-shaped cutterheads have been developed in order to work with wood and other materials. For example, such helical cutterheads are discussed in U.S. Pat. Nos. 5,083,887 to Dotany and 5,904,449 to Satran et al.

Prior art helical cutterheads exhibit certain drawbacks and deficiencies. Many of these prior art helical cutterheads are prone to vibration and other problems, which gives rise to “waste” due to misshaped parts. For example, when working with figured and cross-grained wood, it is common that such prior art helical cutterheads come through unbalanced. Accordingly, damage to the helical cutterhead may ensue, such as, for example, the cutting blades breaking more often and more easily.

There remains a need in the art for a helical cutterhead that includes appropriately aligned or seated blades or knives to produce a shear cut. In addition, there is a need in the art for helical cutterheads that direct the cut material (or shavings) towards the appropriate dust collection systems. There is a further need in the art for helical cutterheads that provide appropriate support to the blades or knives, which reduces vibration and other problems associated therewith.

### SUMMARY OF THE INVENTION

It is, therefore, one object of the present invention to provide a helical cutterhead that overcomes the drawbacks and deficiencies associated with the prior art. It is another object of the present invention to provide a helical cutterhead that includes appropriately aligned components to provide a shear cutting edge. It is a still further object of the present invention to provide a helical cutterhead having seats that support a respective cutting blade. It is yet another object of the present invention to provide a helical cutterhead that is arrangeable to direct material in a variety of directions, and to a dust collection system. It is a further object of the present invention to provide a design process for manufacturing a helical cutterhead.

Accordingly, in one embodiment, provided is a cutterhead for shaping a material. This cutterhead includes a substantially cylindrical body having at least one helically-shaped recess defining a helically-shaped projecting surface with a cutting side. The body further includes a plurality of seats positioned along the projecting surface for connecting, to a respective seat, a plurality of removable cutting blades. Each blade includes multiple blade edges. The seat further includes a substantially planar seat surface defined by engagement walls for contacting a respective blade edge and having an open end for permitting one blade edge to project therefrom. A seat surface is oriented to align the projecting blade edge to a helical angle with respect to the body, to thereby provide a shear cutting edge. The seats further include a connection arrangement for removably attaching a blade within a respective seat.

In another embodiment, provided is a cutterhead for shaping a material. The cutterhead has a substantially cylindrical body having at least one helically-shaped recess defining a helically-shaped projecting surface with a cutting side. The body further includes multiple seats positioned along the projecting surface for connecting, to a respective seat, a plurality of removable cutting blades, each blade having multiple blade edges. Each seat includes a substantially planar seat surface defined by a plurality of engagement walls for contacting a respective blade edge and having an open end for permitting one blade edge to project therefrom. The seats further include a connection arrangement for removably attaching a blade within a respective seat. Further, each seat is oriented to position a blade edge top corner point of a cutting blade to about 15° from an axis extending along the diameter of the body.

In a still further embodiment, provided is a cutterhead for shaping material. This cutterhead includes a substantially cylindrical body having a body diameter. The body includes at least one helically-shaped recess defining a helically-shaped projecting surface having a cutting side, and multiple seats positioned along a projecting surface for connecting, to a respective seat, a plurality of removable cutting blades defining a cut diameter. Each blade has multiple blade edges, and each seat includes a substantially planar seat surface defined by multiple engagement walls for contacting a respective blade edge and having an open end for permitting one blade edge to project therefrom. The seats further include a connection arrangement for removably attaching a blade within a respective seat. Each seat is oriented to position a blade edge top corner point: (i) about 15° from an axis extending along the diameter of the body; (ii) and a distance in the X-direction from an axis extending along the diameter of the body in the direction of the Y-axis, as calculated by the following formula: sin(15)×(Cut Diameter/2); and (iii) at a distance in the Y-direction from an axis extending along the diameter of the body in the direction of the X-axis, as calculated by the following formula: cos(15)×(Cut Diameter/2).

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of one embodiment of a helical cutterhead according to the principles of the present invention;

FIG. 2 is a further perspective view of the helical cutterhead of FIG. 1;

FIG. 3 is an end view of the helical cutterhead of FIG. 1;

FIGS. 4(a)-(c) are top, side and bottom views of a cutting blade for use in connection with a helical cutterhead according to the principles of the present invention;

FIG. 5 is a perspective view of a further embodiment of a helical cutterhead in accordance with the principles of the present invention;

FIG. 6 is a further perspective view of the helical cutterhead of FIG. 5;

FIG. 7 is a perspective view of another embodiment of a helical cutterhead according to the principles of the present invention;

FIG. 8 is an end view of the helical cutterhead of FIG. 7;

FIG. 9 is a plan view of a helical cutterhead according to the principles of the present invention;

FIG. 10 is a perspective view of the helical cutterhead of FIG. 9;

FIG. 11 is a further perspective view of the helical cutterhead of FIG. 9;

FIG. 12 is a plan view of a still further embodiment of a helical cutterhead according to the principles of the present invention;

FIG. 13 is a perspective view of the helical cutterhead of FIG. 12;

FIG. 14 is a further perspective view of the helical cutterhead of FIG. 12;

FIG. 15 is an end view of a helical cutterhead according to the principles of the present invention;

FIG. 16 is a detailed view of a portion of the helical cutterhead of FIG. 15;

FIG. 17 is a detailed view of a helical cutterhead according to the principles of the present invention;

FIG. 18 is a detailed view of a portion of the helical cutterhead of FIG. 17;

FIG. 19 is an end view of a helical cutterhead according to the principles of the present invention; and

FIG. 20 is a detailed view of a portion of the helical cutterhead of FIG. 19.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

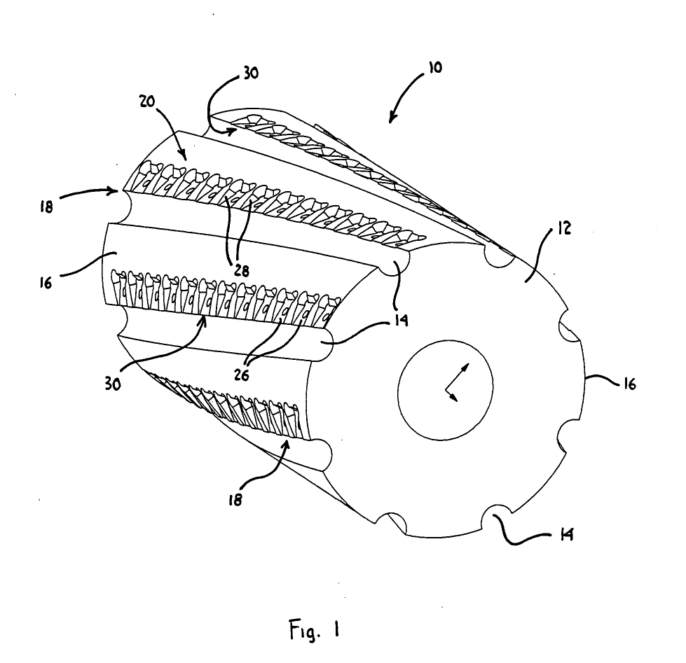

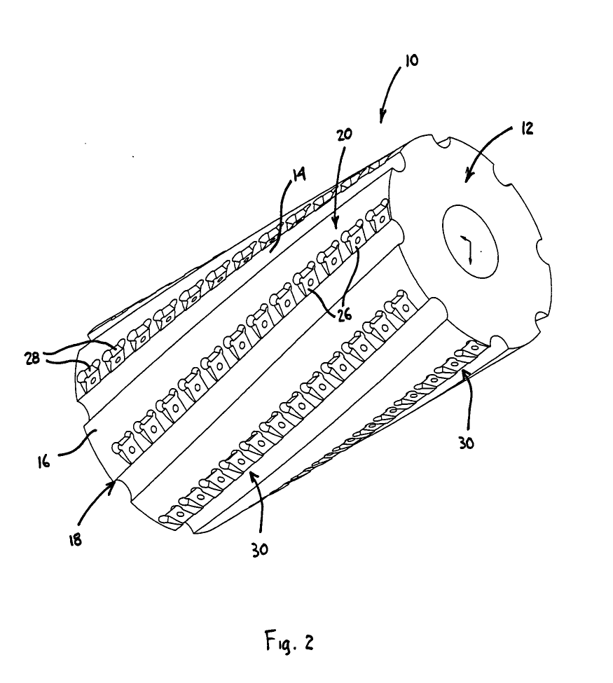

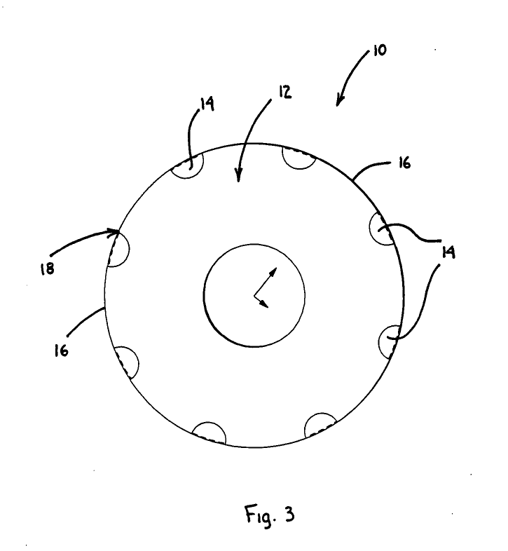

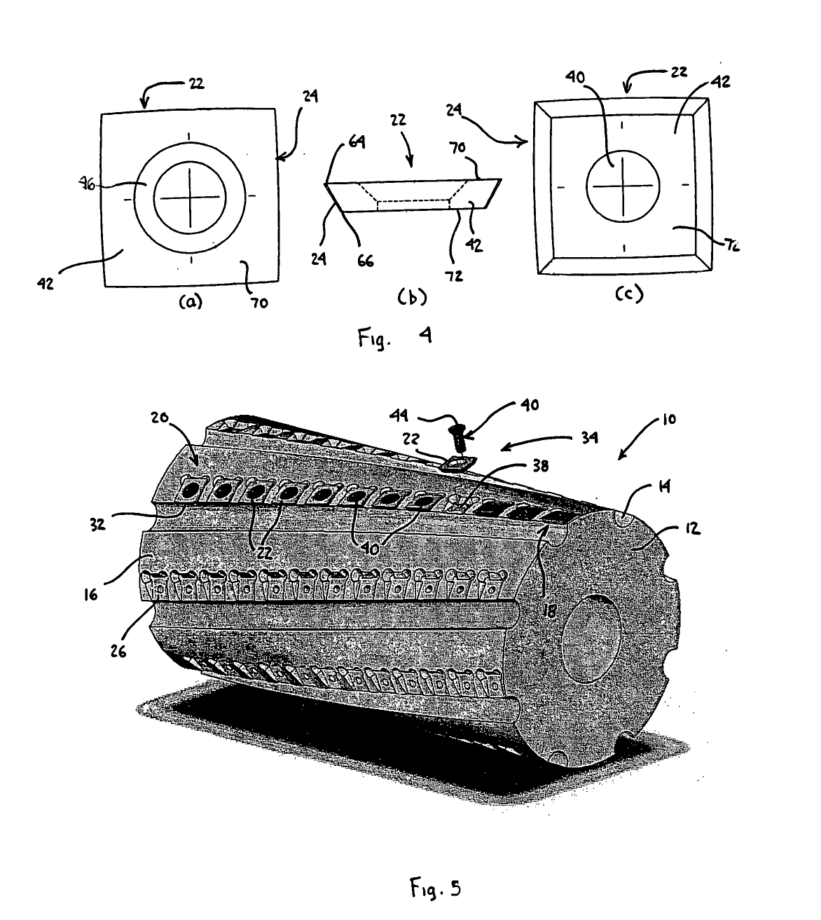

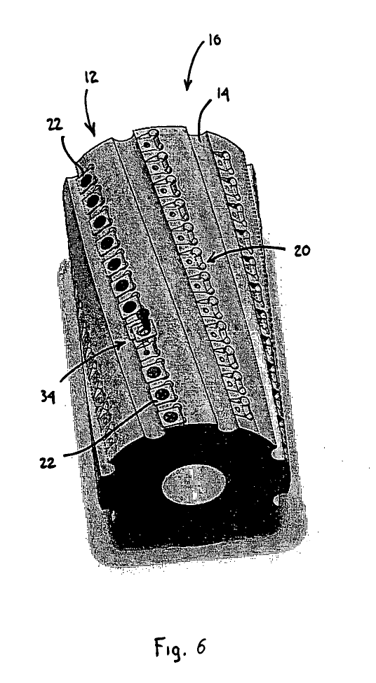

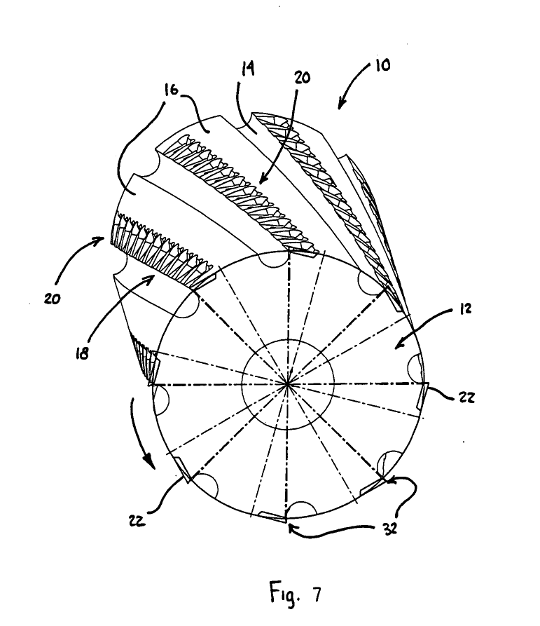

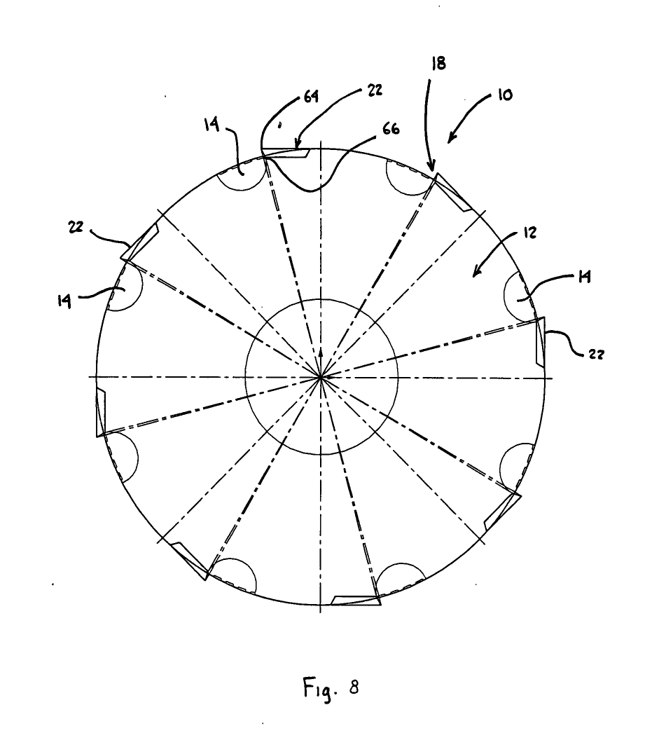

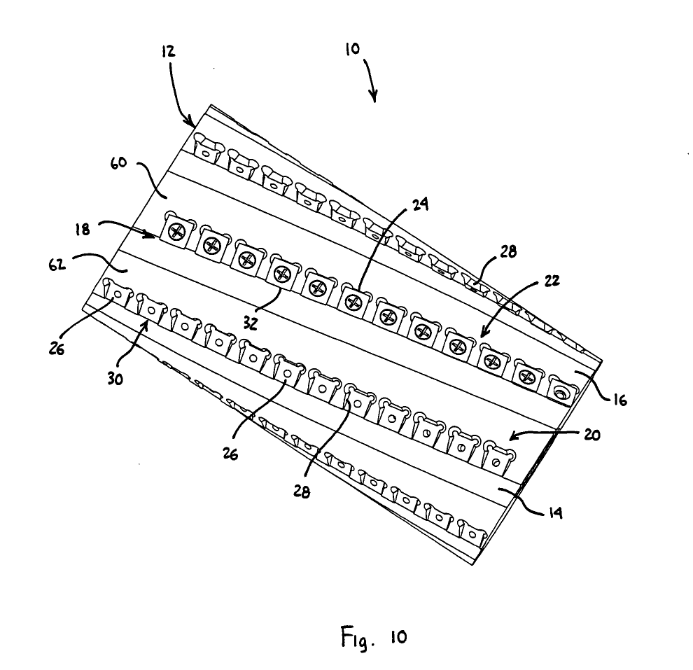

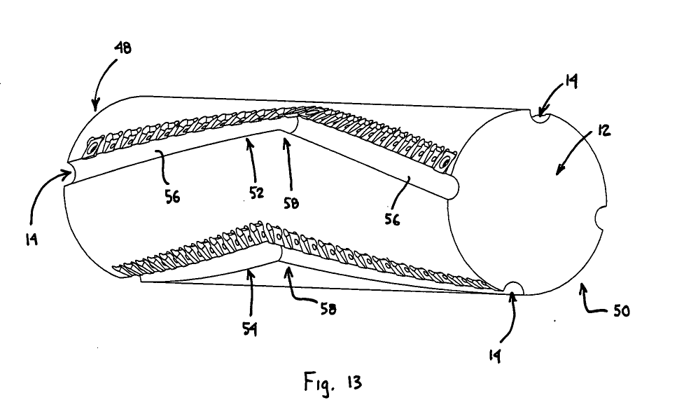

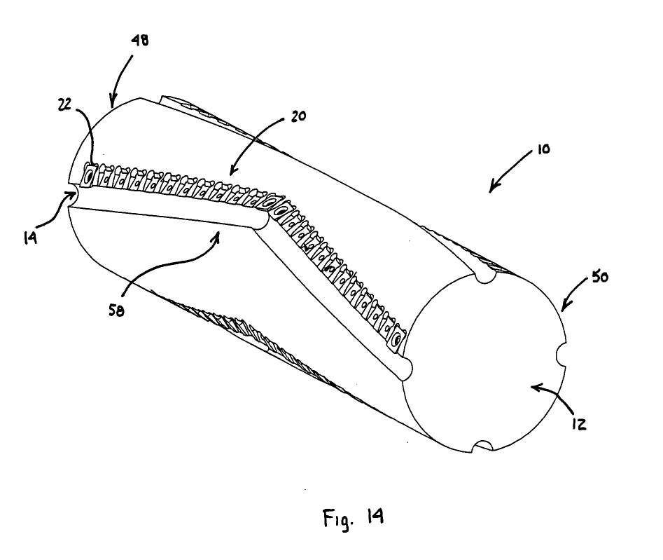

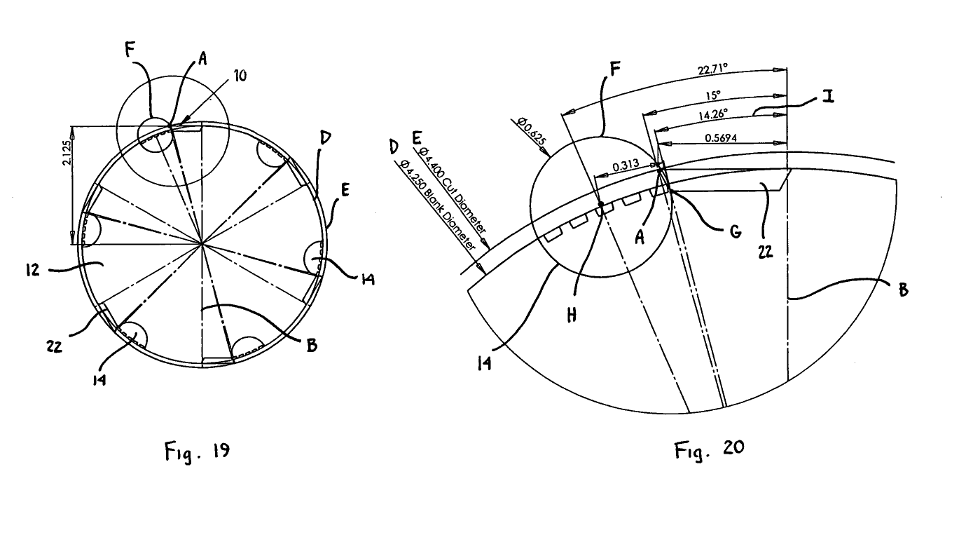

The present invention is directed to a cutterhead 10 for working with and shaping a material, such as figured and cross-grained wood. Various preferred and non-limiting embodiments of the cutterhead 10 are illustrated in FIGS. 1-3 and 5-20. In particular, the present invention is directed to a helical cutterhead 10, or a helically-shaped rotating cutting device or implement.

In one preferred and non-limiting embodiment, the cutterhead 10 includes a substantially cylindrical body 12. This body 12 may be configured in the exemplary cylindrical shape (as illustrated in the figures), or some other operable shape within the scope of the present invention. The body 12 includes at least one, and typically multiple, helically-shaped recesses 14, which define at least one and typically multiple helically-shaped projecting surfaces 16. Each surface 16 includes a cutting side 18.

The body further includes multiple seats 20 positioned along, and preferably recessed within, the projecting surface 16. These seats 20 are configured for permitting the connection, to a respective seat 20, multiple removable cutting blades 22, as illustrated in FIG. 4. Each cutting blade 22 includes multiple blade edges 24, together which form a cut diameter extending along the body 12. The seat 20 includes a substantially planar seat surface 26 defined by multiple engagement walls 28. It is this surface 26 and wall 28 arrangement that provides a recessed seat 20 on the projecting surface 16 of the body 12. The seat 20, also includes an open end 30 for permitting one blade edge 24 to project therefrom. Further, the seat surface 26 and/or the walls 28 are oriented to align the projecting blade edge 32 to a helical angle with respect to the body 12. Such positioning provides a helical and shear cutting edge.

In this embodiment, the cutterhead 10 also includes a connection arrangement 34 for removably attaching a blade 22 within a respective seat 20. In this embodiment, the connection arrangement 34 is in the form of a threaded orifice 36 extending within the seat surface 26 of each seat 20. This threaded orifice 36 is configured to accept a screw 38 therein. Accordingly, each cutting blade 22 includes a blade orifice 40 extending through a blade body 42. In operation, the screw 38 is inserted through the blade orifice 40 and threaded into the orifice 36, thereby securing a cutting blade 22 within a respective seat 20. In order to ensure that the head 44 of the screw 38 does not project from the blade body 42, the blade orifice 40 may include a tapered portion 46. This tapered portion 46 is sized and shaped so as to accept the head 44 of the screw 38 therein, thereby providing a substantially planar blade body 42. See FIG. 4.

In a further preferred and non-limiting embodiment, the seat 20, and in particular the seat surface 26, is in a substantially square-shaped configuration. Therefore, each seat 20 is capable of accepting and attaching a substantially square-shaped cutting blade 22. In this manner, the seat surface 26 and/or the engagement walls 28 provide support of the blade body 42 on three sides, with the projecting blade edge 32 extending from the seat surface 26. In addition, such support assists in preventing vibration, loosening and other damage to the blades 18, which normally results in damage to the finished material.

In a further preferred and non-limiting embodiment, the helically-shaped recess 14 extends substantially from a first end 48 of the body 12 to a second end 50 of the body 12. Normally, multiple recesses 14 are provided. For example, in one embodiment, a first recess 52 and a second recess 54 define a projecting surface 16 between them, as illustrated in FIGS. 1-3 and 5-11. Accordingly, either or both of the first recess 52 and second recess 54 define a continuous recess extending substantially from the first end 48 of the body 12 to the second end 50 of the body 12.

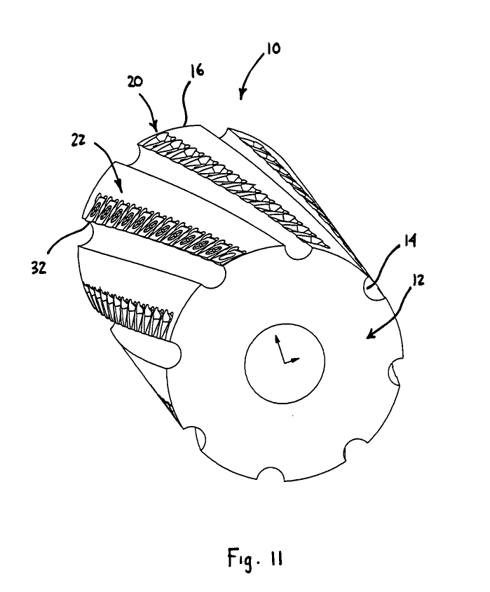

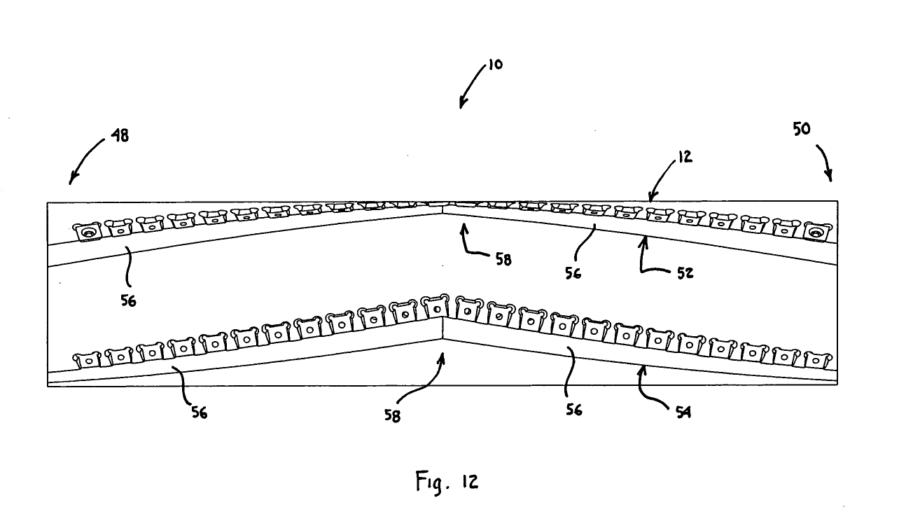

In a further embodiment, this continuous, end-to-end recess is formed by two helically-shaped recess portions 56, which, together, extend from the first end 48 of the body 12 to the second end 50 of the body 12. As best seen in FIG. 12, these recess portions 56 meet at an axial midsection of the body 12, thereby forming a substantially V-shaped continuous recess 58.

One benefit of the specific end-to-end positioning of the recesses 14 is the ability to direct sheared material to an appropriately positioned dust collection system (not shown). In particular, and based upon the orientation and helical shape of the recesses 14, the dust or shavings may be directed to the left, right or center of the body 12. If the V-shaped recess 58 is provided on the body 12, the dust or shavings are directed to a center portion of the body 12, which would be in operational communication with the dust collection system. Not only may the helically-shaped recesses 14 be oriented to direct sheared material in a desired direction, the seat surface 26 may also be oriented to align the projecting blade edge 32 to an angle that also directs sheared material in a desired direction.

In a further preferred and non-limiting embodiment, and as illustrated in FIGS. 16 and 20, the seat 20 is oriented to position a blade edge top corner point A of a cutting blade 18 in the range of about 10 to about 20 degrees from an axis C extending along the diameter of the body 12, as viewed from an end of the body 12. Preferably, the seat 20 is oriented to position the blade edge top corner point A to about 15° from the axis B. Further, and in another embodiment, the length of the helically-shaped recess 14 defines a helical pattern that maintains a constant change of radius for each full revolution around the circumference of the body 12. Accordingly, the length may be about 80 to about 90 inches, and preferably about 85 inches. This means that the length of the recess 14 from the first end 48 of the body 12 to the second end 50 of the body 12 is about 85 inches.

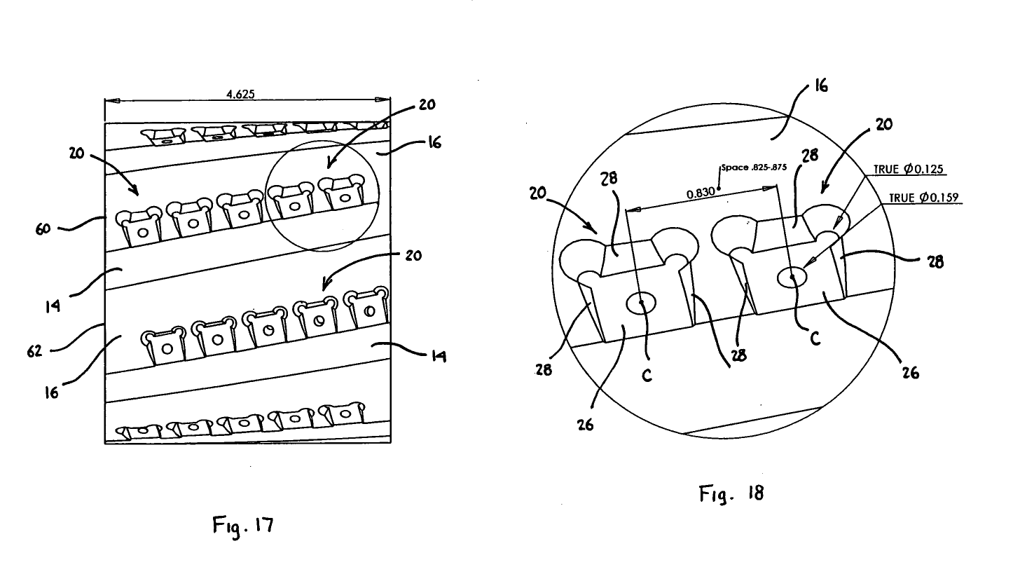

Still further, and as illustrated in FIG. 18, and in another preferred and non-limiting embodiment, two adjacent seats 20 are positioned such that a blade 18 positioned in each seat 20 on the projecting surface 16 is spaced from the adjacent blade 22 positioned on a respective projecting surface 16. Accordingly, a center C of at least two adjacent seats 20 are spaced about 0.8 to about 0.9 inches. In a preferred embodiment, the center C of the adjacent seats 20 are spaced about 0.825 to about 0.875 inches. Such separation or spacing allows for the use of the seats 20 for different sizes and shapes of blades 22, as well as to ensure proper helical alignment and eliminate interference problems.

In another preferred and non-limiting embodiment, and in order to provide a substantially uniform and shearing cut of the material, and as illustrated in FIG. 17, a seat 20 on a first projecting surface 60 and a seat 20 on a second, adjacent projecting surface 62 are positioned, such that the projecting blade edge 32 of the blade 22 positioned on the seat 20 on the first projecting surface 60 spacially overlaps (as the Cut Diameter) the projecting blade edge 32 of the blade 22 positioned on the seat 20 on the second, adjacent projecting surface 62. This overlap may be in the range of about 0.375 to about 0.425 inches. In a preferred embodiment, the overlap is about 0.402 inches.

As seen in FIG. 4, the projecting blade edge 32 includes an upper edge line 64 and a lower edge line 66. In this preferred and non-limiting embodiment, each seat 20 is oriented to position the projecting blade edge 32 of each cutting blade 22 along the helical line conforming with the helically-shaped recess 14, specifically at the cutting side 18 of the projecting surface 16. In order to ensure appropriate flow of the sheared material into and through the recess 14, the lower edge line 66 is substantially flush with the seat surface 26. Based upon the angle, e.g., 30°, between the upper edge line 64 and the lower edge line 66, as well as the conformance of the lower edge line 66 with the recess 14, a smooth transition region is provided for shearing the material down the projecting blade edge 32 and into the recess 14. This transition region is best illustrated in FIGS. 16 and 20.

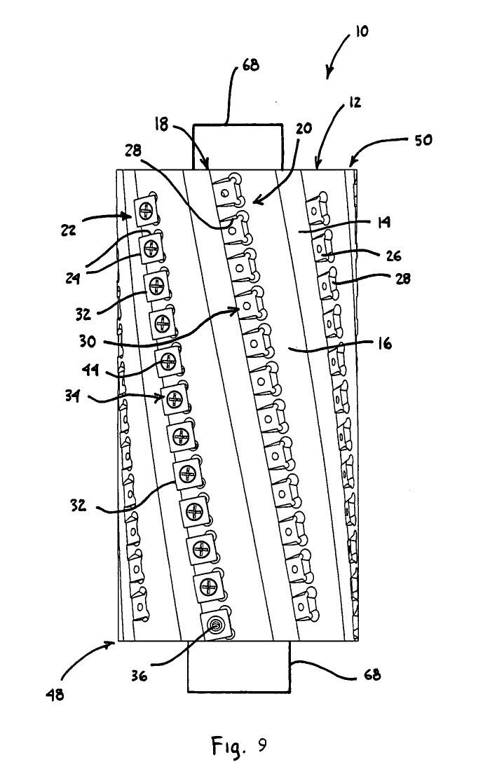

As best seen in FIG. 9, the cutterhead 10 may also include at least one, and typically two, shafts 68 extending from each end of the body 12. The shafts 68 are used to connect to a bearing (not shown) in a cutting system. In particular, these shafts 68 are used to implement a rotational movement of the cutterhead 10, as is known in the art.

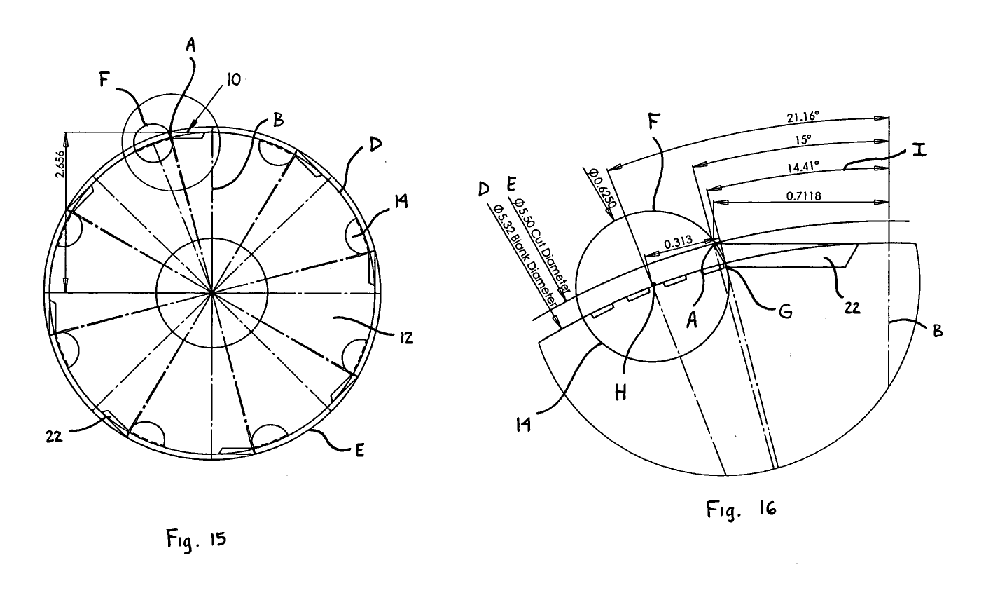

In a further preferred and non-limiting embodiment, provided is a manufacturing and design method for creating a cutterhead 10 as discussed above in detail. As discussed above, and as best seen in FIGS. 16 and 20, each seat 20 is oriented to position the blade edge top corner point A of a cutting blade 22 to about 15° from the axis B extending along the diameter of the body 12, when viewed from an end of the body 12. As also illustrated in FIGS. 15, 16, 19 and 20, the body 12 defines a diameter D, and the upper edge line 64 of the cutting blades 22 define a cut diameter E. In particular, the cut diameter E represents the cut point as the cutterhead 10 is rotated and bears against the work piece.

According to the present invention, and in this preferred and non-limiting embodiment, each seat 20 is further oriented to position the blade edge top corner point A at a distance in the X-direction from the axis B in the direction of the Y-axis, as calculated by the following formula: sin(15)×(Cut Diameter/2). Still further, the blade edge top corner point A is positioned at a distance in the Y-direction from the axis B in the direction of the X-axis, as calculated by the following formula: cos(15)×(Cut Diameter/2). The remaining lines and points of the cutting blade 22 (as positioned by the oriented seat 20) may be calculated based upon this specifically-placed blade edge top corner point A. For example, when the cutting blade 22 is in a substantially square shape, the alignment and positioning of the seat surface 26 and the engagement walls 28 are determined based upon the calculated and positioned blade edge top corner point A.

The recesses 14 may also be determined, in this embodiment, based upon a circle F positioned on the center of the circumference of the body 12 (i.e., on the body diameter D) and tangent to blade edge bottom corner point G of the cutting blade 22. Using this design method, the smooth flow of sheared material is provided. In order to determine a center point H of the circle F, the following formula is used: [sin(arcsin(0.625/Body Diameter)+(Blade Bottom Corner Angle))×(Body Diameter/12)]. In this formula, the blade bottom corner angle I is the angle of the blade edge bottom corner point G from the axis B.

Once the center point H is determined, the geometry of the recess 14 is provided based upon the center point H and the blade edge bottom corner point G. Specifically, this design provides a smooth transition between the blade edge 24 and the recess 14, and this smooth transition results in optimum flow of sheared material down along the blade edge 24 into the recess 14 and toward to the dust collection system.

In a further preferred and non-limiting embodiment, the projecting blade edge 32, which includes the upper edge line 64 and the lower edge line 66, is positioned based upon the orientation of the seat 20. In this embodiment, each seat 20 is oriented to position the projecting blade edge 32 along a helical line conforming with the helically-shaped recess 14. In particular, the upper edge line 64 and upper surface 70 of each blade 22 is substantially contiguous with and tangent to the cut diameter E. Further, the lower edge line 66 and lower surface 72 of the blade 22 is substantially flush with the seat surface 26. Such positioning also provides appropriate support to the cutting blade 22 via the seat surface 26 and/or engagement walls 28.

In this manner, provided is a cutterhead 10 and design basis for producing such a cutterhead 10 that provides an effective and efficient cutting motion in implementation. The body 12 of the cutterhead 10 may be formed from many different materials that meet the standards of the intended application. For example, in woodworking applications, the body 12 may be manufactured from a metal material, steel, carbon steel, stainless steel, 1144 stress-proof steel, etc. Similarly, the cutting blades 22 may be manufactured from a variety of materials. In one preferred and non-limiting embodiment, the cutting blades 22 represent carbide inserts that include carbide tips. Such cutting blades 22 may be manufactured from a variety of materials, including tungsten, and may exhibit a desired grain size, utilize specific binders, and include other modifications and variations as are known in the art. In one example, the cutting blades 22 are in the form of a 15 mm×15 mm carbide inserts.

The helical cutterhead 10 of the present invention appropriately shapes materials, including, but not limited to, figured and cross-grained wood. The cutterhead 10 increases the yield when compared to the prior art arrangements. Still further, the cutterhead 10 produces typical jointer-ridge edges, when used in a jointer application. Due to the helical configuration of the cutterhead 10, chip ejection is enhanced by directing chip flow to the center of the body 12 (when using the V-shaped recess 58), or to the left or right of the body 12 (when using the continuous end-to-end helical configuration). When implemented in a woodworking capacity, the helical cutterhead 10 of the present invention significantly reduces grain tear-out in figured woods. Further, due to the unique configuration and aerodynamic geometry of the cutterhead 10, noise from this cutterhead 10 is reduced approximately 15-20 Db. Still further, the cutterhead 10 may be custom manufactured to fit a variety of given applications, e.g., for planers, jointers and molders. Still further, the cutterhead 10 of the present invention is provided with design aspects that maximize chip ejection.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A cutterhead for shaping a material, comprising:
a substantially cylindrical body, including:
(A) at least one helically-shaped recess defining a helically-shaped projecting surface having a cutting side; and
(B) a plurality of seats positioned along the projecting surface for connecting, to a respective seat, a plurality of removable cutting blades, each blade having a plurality of blade edges, wherein each seat includes:
(i) a substantially planar seat surface defined by a plurality of engagement walls for contacting a respective blade edge and having an open end for permitting one blade edge to project therefrom, wherein the seat surface is oriented to align the projecting blade edge to a helical angle with respect to the body, to thereby provide a shear cutting edge; and
(ii) a connection arrangement for removably attaching a blade within a respective seat.

2. The cutterhead of claim 1, wherein the at least one helically-shaped recess extends substantially from a first end of the body to a second end of the body.

3. The cutterhead of claim 1, further comprising a first and second helically-shaped recess defining the projecting surface therebetween.

4. The cutterhead of claim 3, wherein at least one of the first and second helically-shaped recesses define a continuous recess extending substantially from a first end of the body to a second end of the body.

5. The cutterhead of claim 4, wherein the continuous recess is formed by two helically-shaped recesses meeting substantially at an axial mid-section of the body, thereby forming a substantially V-shaped continuous recess.

6. The cutterhead of claim 1, wherein at least one seat is oriented to position a blade edge top corner point of a cutting blade in the range of about 10° to about 20° from an axis extending along the diameter of the body.

7. The cutterhead of claim 4, wherein at least one seat is oriented to position a blade edge top corner point of a cutting blade about 15° from an axis extending along the diameter of the body.

8. The cutterhead of claim 1, wherein the seat surface of at least one seat is oriented to align the projecting blade edge to an angle that directs sheared material in a desired direction.

9. The cutterhead of claim 1, wherein the helically-shaped recess is oriented to direct sheared material in a desired direction.

10. The cutterhead of claim 1, wherein the length of the helically-shaped recess defines a helical pattern that maintains a constant change of radius for each full revolution around the circumference of the body.

11. The cutterhead of claim 10, wherein the length is in the range of about 80 to about 90 inches.

12. The cutterhead of claim 11, wherein the length is about 85 inches.

13. The cutterhead of claim 1, wherein at least two adjacent seats are positioned such that a blade positioned in a seat on the projecting surface is spaced from an adjacent blade positioned on the projecting surface.

14. The cutterhead of claim 13, wherein the center of at least two adjacent seats are spaced about 0.8 to about 0.9 inches.

15. The cutterhead of claim 14, wherein the center of at least two adjacent seats are spaced about 0.825 to about 0.875 inches.

16. The cutterhead of claim 1, wherein a seat on a first projecting surface and a seat on a second, adjacent projecting surface are positioned such that the projecting blade edge of the blade positioned on the seat on the first projecting surface spatially overlaps the projecting blade edge of the blade positioned on the second, adjacent projecting surface.

17. The cutterhead of claim 16, wherein the overlap is in the range of about 0.375 to about 0.425 inches.

18. The cutterhead of claim 17, wherein the overlap is about 0.402 inches.

19. The cutterhead of claim 1, wherein the projecting blade edge comprises an upper edge line and a lower edge line, wherein each seat is oriented to position the projecting blade edge of each cutting blade along a helical line conforming with the helically-shaped recess, and wherein the lower edge line is substantially flush with the seat surface.

20. The cutterhead of claim 1, further comprising at least one shaft extending from an end of the body and configured for connection to a bearing in a cutting system.

21. The cutterhead of claim 1, wherein at least one seat is configured to support a cutting blade positioned therein on a plurality of sides or edges of the cutting blade.

22. A cutterhead for shaping a material, comprising:
a substantially cylindrical body, including:
(A) at least one helically-shaped recess defining a helically-shaped projecting surface having a cutting side; and
(B) a plurality of seats positioned along the projecting surface for connecting, to a respective seat, a plurality of removable cutting blades, each blade having a plurality of blade edges, wherein each seat includes:
(i) a substantially planar seat surface defined by a plurality of engagement walls for contacting a respective blade edge and having an open end for permitting one blade edge to project therefrom; and
(ii) a connection arrangement for removably attaching a blade within a respective seat;
wherein each seat is oriented to position a blade edge top corner point of a cutting blade to about 15° from an axis extending along the diameter of the body.

23. A cutterhead for shaping a material, comprising:
a substantially cylindrical body having a body diameter, including:
(A) at least one helically-shaped recess defining a helically-shaped projecting surface having a cutting side; and
(B) a plurality of seats positioned along the projecting surface for connecting, to a respective seat, a plurality of removable cutting blades defining a cut diameter, each blade having a plurality of blade edges, wherein each seat includes:
(i) a substantially planar seat surface defined by a plurality of engagement walls for contacting a respective blade edge and having an open end for permitting one blade edge to project therefrom; and
(ii) a connection arrangement for removably attaching a blade within a respective seat;
wherein each seat is oriented to position a blade edge top corner point:
(i) about 15° from an axis extending along the diameter of the body;
(ii) at a distance in the X-direction from an axis extending along the diameter of the body in the direction of the Y-axis, as calculated by the following formula:
sin(15)×(Cut Diameter/2)
(iii) at a distance in the Y-direction from an axis extending along the diameter of the body in the direction of the X-axis, as calculated by the following formula:
cos(15)×(Cut Diameter/2).

24. The cutterhead of claim 23, wherein the cutting blade is in a substantially square shape; and wherein the alignment and positioning of the seat surface and the engagement walls are determined based upon the calculated blade edge top corner point.

25. The cutterhead of claim 23, wherein the shape of the at least one recess is determined based upon a circle positioned on the center of the circumference and tangent to a blade edge bottom corner point of the cutter blade, thereby providing smooth flow of sheared material.

26. The cutterhead of claim 25, wherein the center of the circumference is determined according the following formula:
[sin(arcsin(0.625/Body Diameter)+(Blade Bottom Corner Angle))×(Body Diameter/2)]
wherein the Blade Bottom Corner Angle is the angle of the blade edge bottom corner point of the cutter blade from the axis extending along the diameter of the body.

27. The cutterhead of claim 23, wherein the projecting blade edge comprises an upper edge line and a lower edge line, wherein each seat is oriented to position the projecting blade edge of each cutting blade along a helical line conforming with the helically-shaped recess, wherein the upper edge line and upper surface of each blade is substantially contiguous with and tangent to the cut diameter, and wherein the lower edge line and lower surface of each blade is substantially flush with the seat surface.

28. The cutterhead of claim 1, wherein at least one seat is configured to support a cutting blade positioned therein on a plurality of sides or edges of the cutting blade.
